(19) United States
(12) Patent Application Publication
(10) Pub. No.: US 2017/0159524 A1
(43) Pub. Date: Jun. 8, 2017

(54) HEATING MODULE AND TANK SYSTEM

(71) Applicant: DBK David + Baader GmbH, Rülzheim (DE)

(72) Inventor: Sven Dehrmann, Schaidt (DE)

(21) Appl. No.: 15/316,356

(22) PCT Filed: May 29, 2015
(86) PCT No.: PCT/EP2015/061974

§ 371 Date: Dec. 6, 2016

(30) Foreign Application Priority Data
Jun. 6, 2014 (DE) 10 2014 108 074.2

(51) Int. Cl. F01N 3/20; H05B 3/40; H05B 3/14; F01N 3/28

(52) U.S. Cl. CPC F01N 3/2013; F01N 3/2066; F01N 3/2896; H05B 3/40; H05B 3/146; F01N 2610/02; H05B 2203/02; H05B 2203/021

(57) ABSTRACT

A heating module and a tank system comprising the heating module is disclosed. The heating module has a heating unit which is equipped with at least one heating element, the heat thereof being transferred to an operating fluid via a plate-shaped distributor plate.

### CROSS-REFERENCE TO RELATED APPLICATIONS

This application is a national stage of, and claims priority to, Patent Cooperation Treaty Application No. PCT/EP2015/061974, filed on May 29, 2015, which claims priority to German Application No. DE 10 2014 108 074.2 filed on Jun. 6, 2014, each of which applications are hereby incorporated herein by reference in their entireties.

### DESCRIPTION

The disclosure relates to a heating module for melting or heating an operating fluid and a tank system comprising such heating module.

At very low external temperatures in the sub-zero range, operating fluids such as a urea solution in a SCR catalytic converter or a window or headlamp cleaning fluidfreeze and first have to be thawed for the intended use after starting the vehicle. This is especially critical in the case of SCR catalytic converters that are used to reduce the nitrogen oxide emissions of internal combustion engines, for example diesel engines.

In SCR (Selective Catalytic Reduction) technology the nitrogen oxides are chemically converted with an appropriate reducing agent into the substances nitrogen and water which are environmentally safe. The reducing agent used is ammonia in vaporous or gaseous form which is produced from an aqueous urea solution having a urea content of 32.5% by weight and is introduced to the exhaust gas flow. Said aqueous urea solution is offered today in standardized form with the brand name AdBlue®. T This aqueous urea solution has the problem that it will freeze below −11° C. and thus cannot be conveyed to the catalytic converter any more.

In order to reduce the nitrogen oxide emissions especially forming during cold start of a vehicle, it is therefore required to thaw said urea solution as quickly as possible. In DE 20 2006 010 615 U1 to applicant a system is suggested in which a melting tank of smaller volume is accommodated in a large urea tank, wherein both tanks hold urea solution. The smaller melting tank is provided with an efficient heating module by which the relatively small urea volume is thawed very quickly when starting the vehicle so that the SCR catalytic converter can be operated by withdrawing melted urea solution from the small melting tank so as to reduce the nitrogen emissions.

In the document EP 2 341 224 A1 to applicant a heating module is described in which PTC resistance elements are used as heating elements the heat of which is transferred via rib-shaped profiled members to the operating fluid, for example the urea solution. The profiled members are designed as an extrusion-molded profile or as a pressure die casting and jointly confine a receiving chamber for the PTC resistance elements. Moreover, at the profiled members a seat for a filter is formed. The arrangement comprising the profiled members and the PTC resistance elements received therein is surrounded by injection-molding, preferably with plastic material, by casting, or sheathed in any other way in a fluid-tight manner.

It is a drawback of this solution that the profiled members, on the one hand, occupy considerable space in the tank accommodating the operating fluid. Moreover, said profiled members are relatively heavy due to their solid configuration so that, on the one hand, a lot of energy is required to heat them to the operating temperature during cold start and, on the other hand, the weight of the SCR mechanism is determined by the heating module to a considerable degree.

Another drawback of this concept consists in the fact that the injection-molding tool for surrounding the profiled members by injection-molding has to be designed to be relatively voluminous and thus expensive so that the investment costs for manufacturing such a heating module are significant.

The object present the disclosure is to provide a heating module and a tank system configured to include such a heating module in which the afore-described drawbacks are eliminated.

This object is achieved by a heating module and a tank system as described below.

Advantageous features of the heating module and tank system are additionally disclosed.

The heating module according to the disclosure serves for melting or heating an operating fluid accommodated in a tank system such as a urea solution of an SCR catalytic converter or a windscreen or headlamp cleaning fluid. The heating module includes a heating unit the heat of which is transmitted to the operating fluid via a heat distribution element. The heating module further is preferably designed to include a fluid outlet for the operating fluid. In accordance with the disclosure, the heat distribution element is in the form of a substantially plate-shaped distributor plate supporting, on a large surface, the heating unit of the heating module, wherein the heating unit and the distributor plate are at least partially covered together by injection-molding and/or painted or coated in a fluid-tight manner.

“Plate-shaped” in this context means a body having large surfaces which are arranged substantially in parallel to each other, the parallel distance substantially defining the thickness of the distributor plate. Said thickness is by far smaller than the length and/or width dimensions of the large surface.

The sheathing preferably extends at least around the area of the heating unit so that the latter is sealed against the urea solution.

Advantageously, the structure of the heating module according to the disclosure is simpler than the one known from the state of the art, as the pre-assembled heating unit merely has to be mounted on the plate-shaped distributor plate. The geometry of the distributor plate may be adapted with minimum effort to the respective tank dimensions so that an optimum heat transfer from the distributor plate to the operating fluid is ensured.

The plate-shaped distributor plates can be easily manufactured from plate material—so that the investment costs are clearly reduced as compared to the state of the art, as in the latter comparatively expensive die-casting tools having a short service life are required to manufacture die-cast profiled members. If the profiled members are designed as extrusion-molded profiles in the state of the art, considerable restrictions as regards to the possible geometry are given so that it is difficult to adapt them optimally to the respective tank.

In an especially simple embodiment, the distributor plate is made of an appropriately heat-conductive metal, preferably aluminium by stamping or the like. As a matter of course, also other methods such as laser cutting, machining methods etc. may be used to form the distributor plate of a plate material. Other appropriately heat-conductive materials may also be used.

Of advantage, a fluid outlet for the operating fluid is formed at the heating unit, wherein the fluid outlet is in fluid communication with a suction connection on the distributor plate side through which the operating fluid can be discharged from the tank.

In an embodiment it is provided for the distributor plate and the heating unit to jointly form a receiving chamber for at least one heating element, wherein preferably a ground connection is provided on the side of the distributor plate and a positive connection is provided on the side of the heating unit.

Heating of the operating fluid is especially efficient when the fluid outlet is heated at least in portions and passes through the distributor plate and/or the heating unit into the suction connection.

The fluid outlet may be heated, for example, via a ring-shaped heating transfer element which encompasses the outlet connection at least in portions for heating. The ring-shaped heat transfer element is equally heated by the heating unit. Independent heating of the fluid outlet is possible as well.

Advantageously, on a large surface of the distributor plate distant from the heating unit a return passage may be formed which, on the one hand, ends into the suction connection and, on the other hand, ends in to a return port of the plate.

The manufacture of said return passage and the configuration of the distributor plate are especially simple when the return passage is formed during injection-molding in the plastic material. Accordingly, also heating of the return passage via the distributor plate is ensured.

In one example, during covering by injection-molding, a mounting flange encompassing an electric connection of the heating unit and the fluid outlet is formed. Via the mounting flange the heating module is mounted on the tank, wherein the electric connection and the fluid outlet end outside the tank and do not get into contact with the operating fluid.

The assembly of the heating module is especially simple when the fastening flange is a welding flange.

In the case that filtering of the operating fluid is required a seat for a filter may be formed on the distributor plate and/or on the heating unit. In this case, too, the area of the filter is heated directly or sequentially. The seat may be formed, for example, during covering by injection-molding.

The sealing of the receiving chamber for the at least one heating unit is especially simple when a sealing element is provided on a peripheral edge of the heating unit on the distributor plate side. The sealing element may be attached by a multi-component injection-molding technique or may be inserted as a separate sealing element.

For monitoring the temperature a temperature sensor may be provided.

The assembly of the heating module is especially simple when the heating unit is pre-positioned or fixed on the distributor plate by engaging means or the like prior to covering by injection-molding.

The at least one heating element may be a PTC resistance element, a wire resistor, a tubular heating element, a film heating element, an induction heating element or the like.

The connection of the heating elements is especially simple when at least one spring is provided in the receiving chamber by which the at least one heating element is biased against the distributor plate for producing the ground contact.

A housing of the connecting plug, part of the fluid outlet and other functional elements of the heating module may be formed during covering by injection-molding so that the base members of the distributor plate and of the heating unit can be designed in a relatively simple manner.

In the case that, during sheathing, fissures occur in the sheathing due to thermal tensions, the heating module may be provided with appropriate elements for compensating such tensions.

The elements may be compensating elements which are introduced between the sheathing and the distributor plate and, resp., the heating element.

It is also possible to design the distributor plate to include elastic beads or the like. The distributor plate may be provided with angular sections for compensating tensions in a further solution. In principle, it is also possible to impart a preload to the distributor plate which is compensated when the thermal tensions occur so that the structure becomes free from tensions.

Another option is to sheath the heating module substantially only in the area of the heating unit so that the latter is sealed against the urea solution in a fluid-tight manner. Areas of the distributor plate that are distant from the heating unit may remain uncoated when the appropriate material has been chosen or else can be provided with a simpler coating, for example a varnish layer or the like.

A preferred embodiment of the disclosure shall be illustrated in detail hereinafter by way of schematic drawings in which:

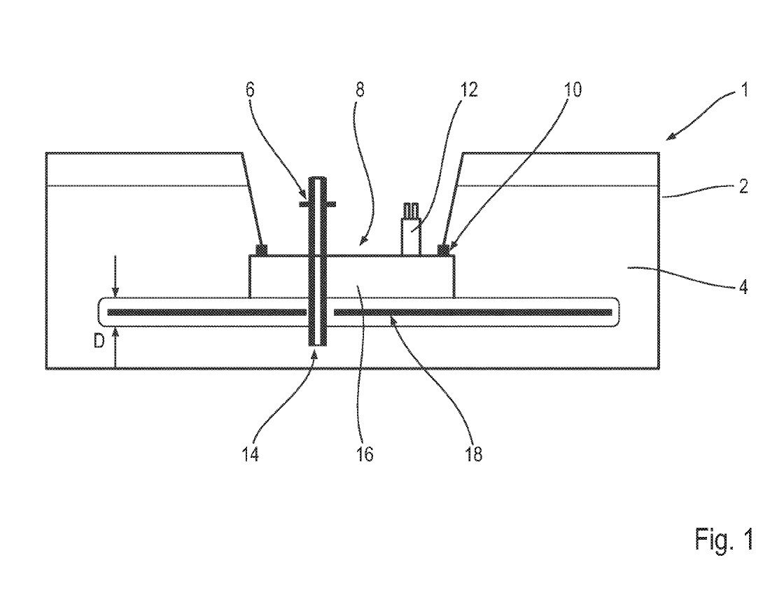

FIG. 1 shows a strongly schematized view of a SCR tank in which a heating module according to the invention is accommodated;

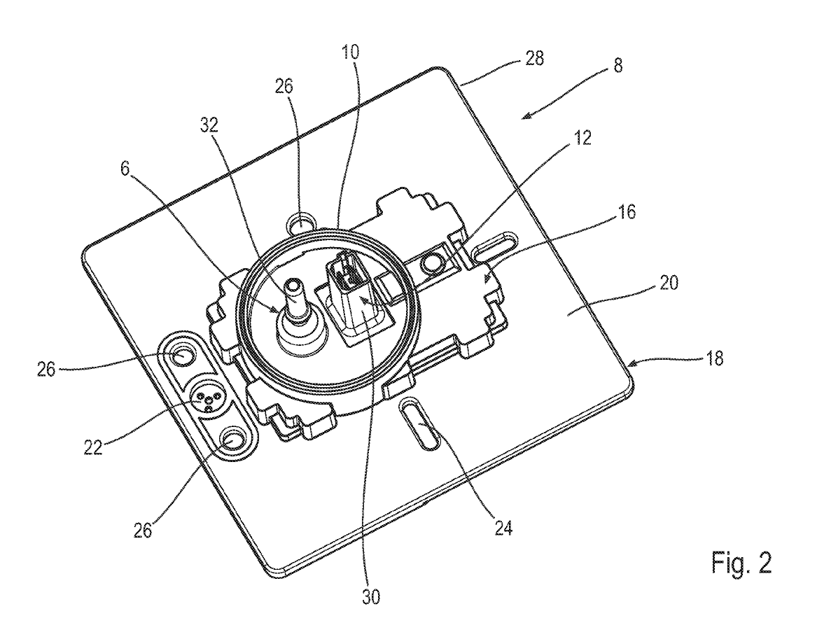

FIG. 2 shows a heating module according to the disclosure in a top view;

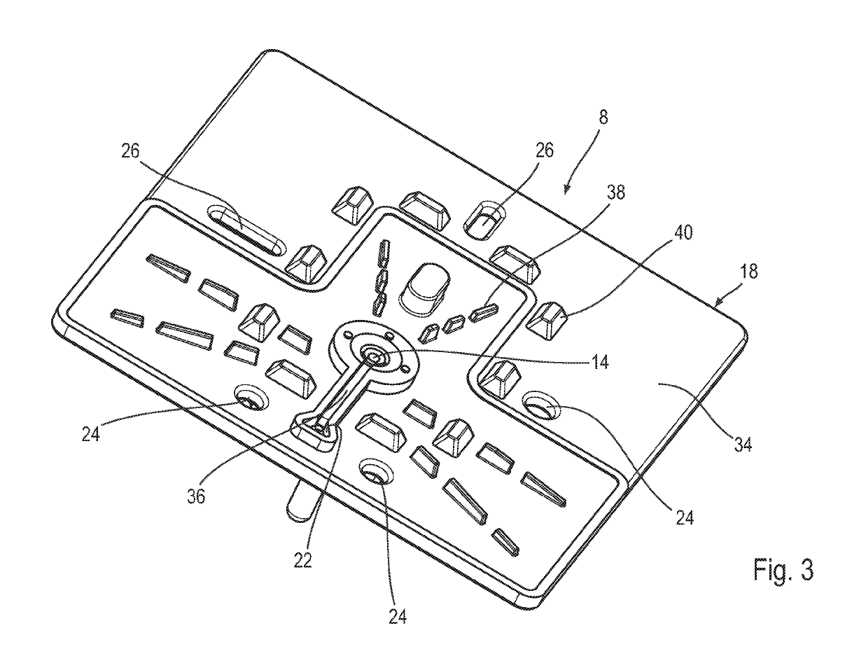

FIG. 3 shows the heating module of FIG. 2 in a bottom view;

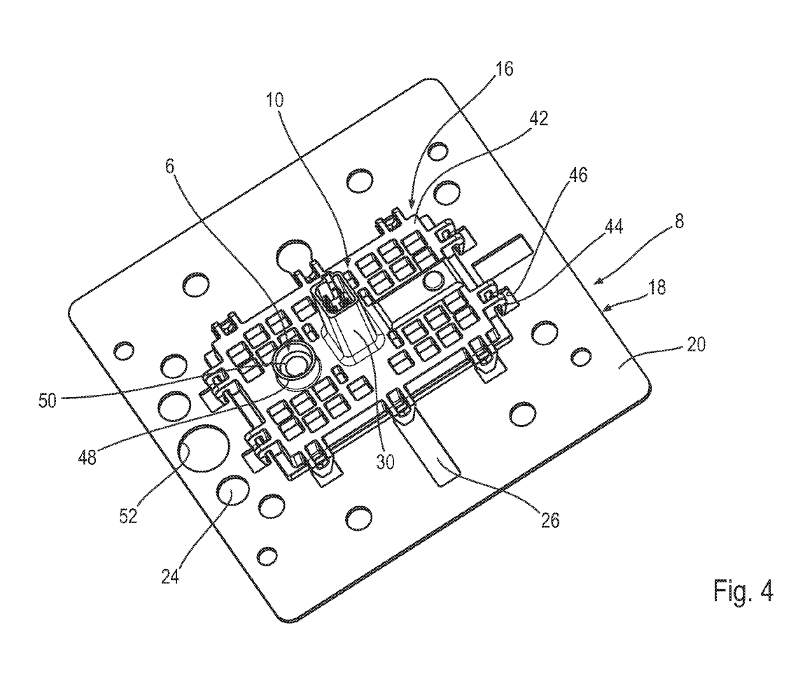

FIG. 4 shows the heating module in a view corresponding to FIG. 2 without being covered by injection-molding;

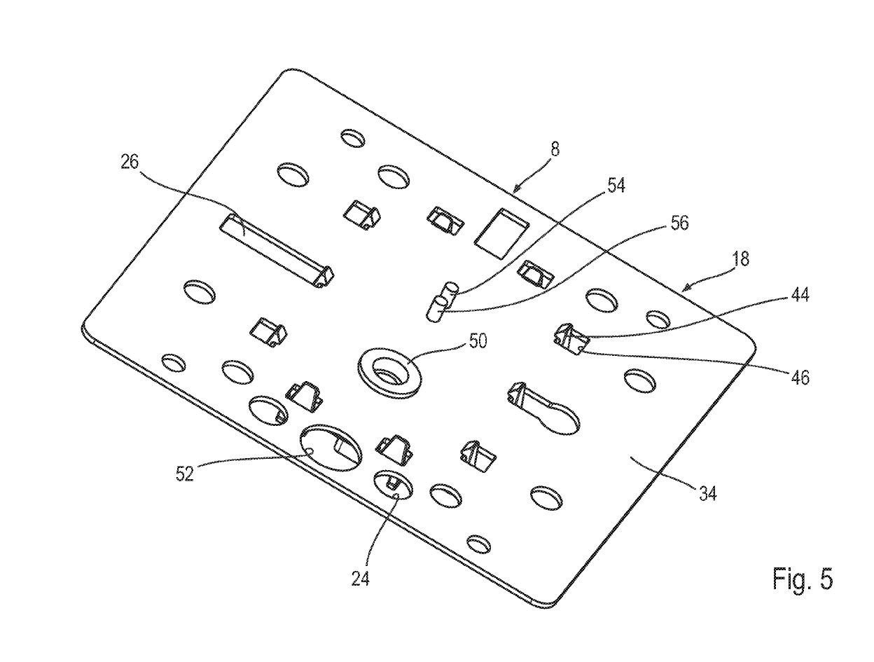

FIG. 5 shows a distributor plate of the heating module according to FIGS. 2 to 4;

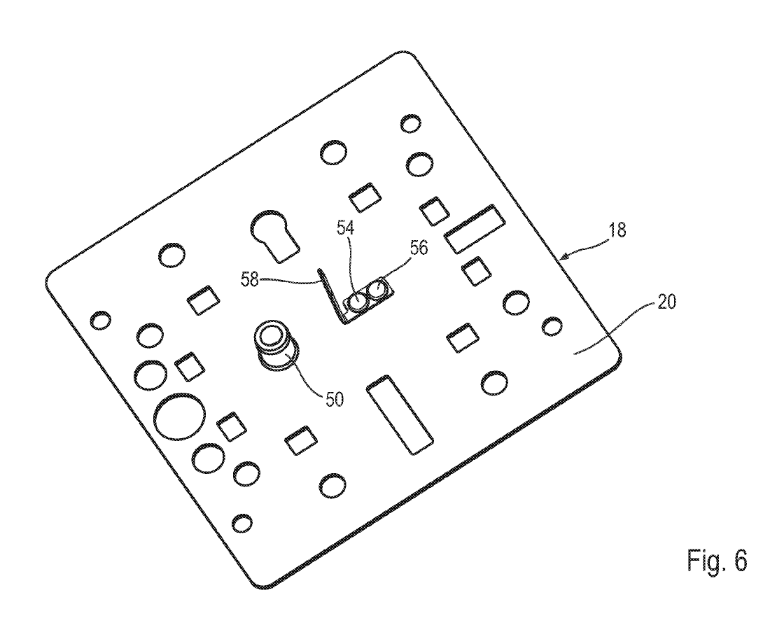

FIG. 6 shows the distributor plate according to FIG. 5 including several fittings;

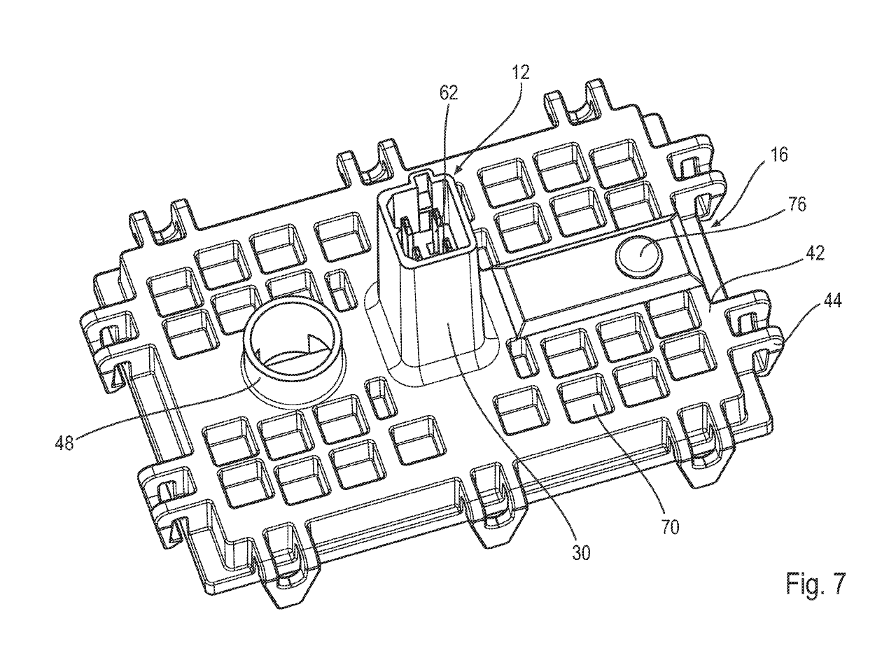

FIG. 7 shows a view corresponding to FIG. 4 of a heating unit of the heating module;

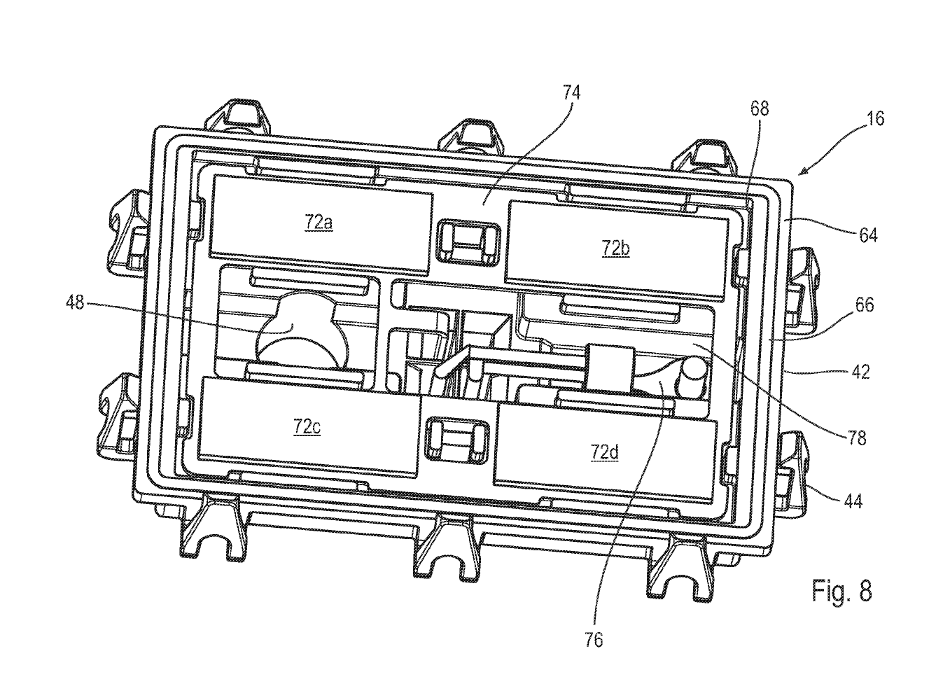

FIG. 8 shows a view from the bottom of the heating unit according to FIG. 7;

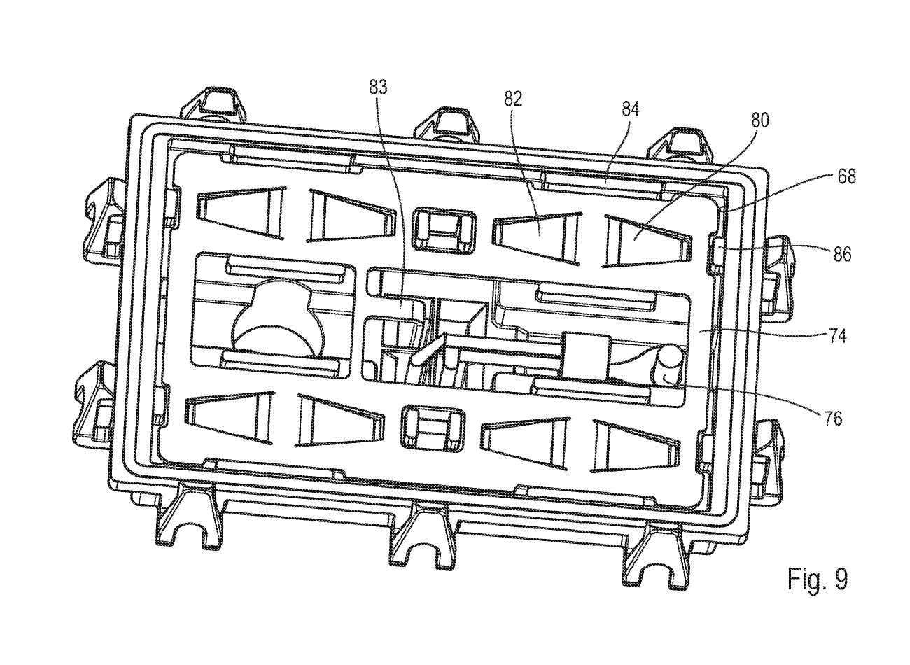

FIG. 9 shows a view corresponding to FIG. 8 without any PTC resistance elements;

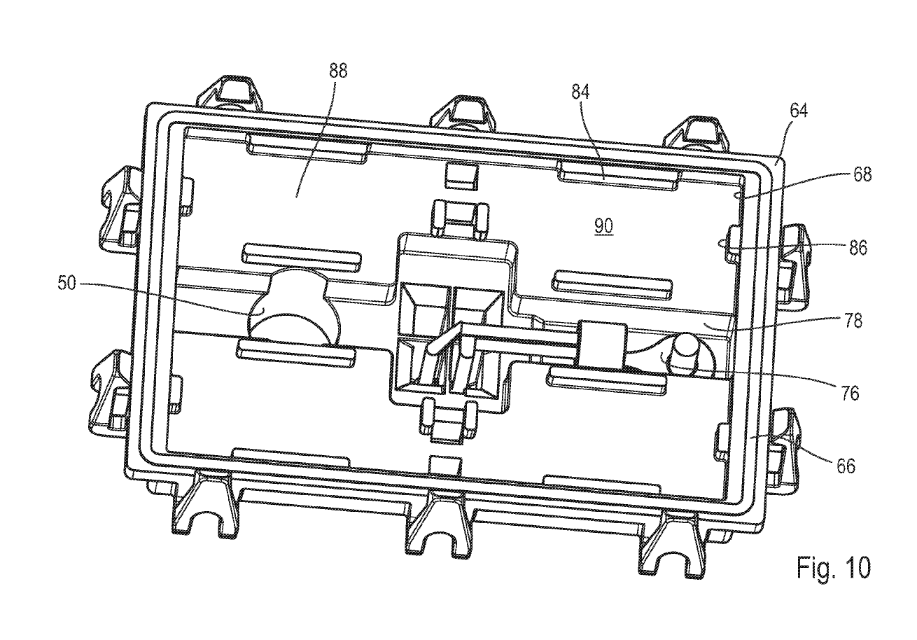

FIG. 10 shows a view corresponding to FIGS. 8 and 9 having no contact latch, which renders visible a temperature sensor, and

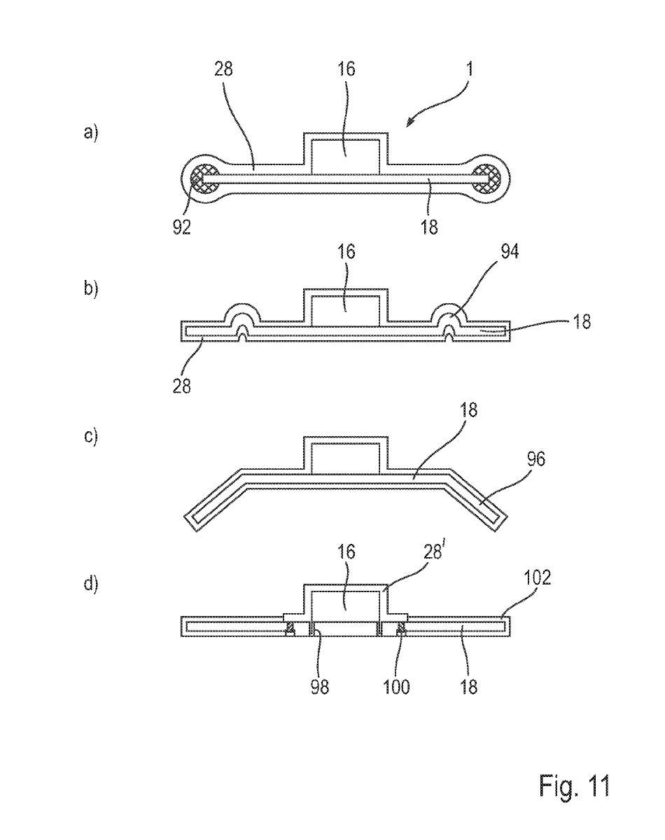

FIG. 11 shows variants of the heating module in which the formation of fissures of the sheathing due to thermal tensions is minimized.

FIG. 1 shows, in an extremely strongly schematized form, a tank system 1 of a SCR catalytic converter comprising a SCR tank 2 receiving a urea solution 4. The tank 2 may be made, for example, of two injection-molded or deep-drawn parts or by a blow molding process.

The urea solution 4 may be discharged from the tank 2 via a fluid outlet 6. In the shown embodiment said fluid outlet 6 is designed to have a connecting piece to which a hose line may be attached which leads to the SCR catalytic converter (not shown). The fluid outlet 6 in the illustrated embodiment is part of a heating module 8 which is connected in a fluid-tight manner to the tank 2 via a mounting flange 10 so that the fluid outlet 6 and an electric connecting plug 12 are arranged outside the tank 2. The urea solution 4 is sucked via a suction connection 14 from the tank and then exits the tank 2 via said fluid outlet 6. The heating module 8 includes a heating unit 16 comprising electric heating element to which current is supplied via the connecting plug 12. The heat transfer to the urea solution 4 takes place via a distributor plate 18 the large surfaces of which extend approximately perpendicularly to the plane of projection in FIG. 1 and the thickness D of which is substantially smaller than the width or length extension of the distributor plate 18. The outer dimensions of the distributor plate 18 are adapted to the tank dimensions so that optimum heat transfer is enabled. The surface area of the heating unit 16 is substantially smaller than the surface of the distributor plate 18 so that the latter projects from the periphery of the heating unit 16.

The tank 2 illustrated in FIG. 1 may be arranged, for example, as a melting tank inside a larger tank, wherein a fluid communication to the larger tank has to be provided in this case. As a matter of course, it is also possible, however, to design one single tank 2 including such heating module 8 so as to defrost the urea solution 4 and heat it up to the operating temperature.

FIG. 2 illustrates an example of the heating module 8. As explained, the heating unit 16 is attached to large surface 20 of the distributor plate 18 visible in FIG. 2. Moreover, there is visible the electric connecting plug 12 being designed with the connecting face as required. Adjacent to the connecting plug 12 the fluid outlet 6 is configured to have a connecting piece 32 to receive e.g. a hose or a quick connector. The mounting flange 10 encompasses both the fluid outlet 6 and the connecting plug 12. In the shown example the mounting flange 10 is a weld flange which is welded to the upper part of the tank 2 in a fluid-tight manner (FIG. 1) so that the connecting plug 12 and the fluid outlet 6 are accessible from outside.

As indicated in FIG. 1, the actual heating unit 16 immerses with the distributor plate 18 into the urea solution 4. As shown in FIG. 3, a return inlet 22 for the urea solution which is in fluid communication with a rear suction connection 14 via a return passage 36 ends into the large surface 20.

In FIG. 2 there are further evident several elongate breakthroughs 24 and circular breakthroughs 26 provided to improve convection in the tank so that a uniform heating of the urea solution 4 is ensured. Moreover, the breakthroughs 24, 26 also serve to optimize the surrounding by injection-molding (distortion) and as fixing points during surrounding by injection-molding.

In the representation according to FIG. 2 the distributor plate 18 includes an approximately rectangular large surface 20—this geometry may be selected depending on the tank dimensions. The distributor plate 18 thus is not limited to the rectangular shape but may take practically any plate-shaped contour. As already mentioned, the outer dimensions of the large surface 20 are larger than the thickness D (cf. FIG. 1) of the distributor plate 18.

The final connection of the heating unit 16 to the distributor plate 20 is brought about by a sheathing which is preferably formed by covering by injection-molding or casting so that the outer contours of the heating module 8 are completely sheathed. The sheathing hereinafter shall be referred to as surrounding by injection-molding 28. The plastic covering by injection-molding 28 forms, inter alia, the mounting flange 10 and the connecting plug 32. Moreover, the covering by injection-molding also serves to protect the distributor plate against the aggressive AdBlue.

FIG. 3 illustrates a bottom view of the heating module 8. In this view a lower large surface 34 of the distributor plate 18 is evident. In the large surface 34 the return inlet 22 ends into a return passage 36 extending to the suction connection 14. Also the breakthroughs 24 and 26 for enhancing the convection and for fixing the components are visible. A filter may be attached to the suction connection 14, wherein in this area a plurality of spacers 38 and, resp., support elements for such filter are provided.

The prism-shaped projections 40 at the large surface 34 of the distributor plate 18 are injection-moldings of engaging elements by which the heating unit 16 is connected to the distributor plate 18 for pre-assembly. Accordingly, in the shown example a total of ten engaging elements are formed to connect the heating unit 16 to the distributor plate 18.

FIG. 4 illustrates views of the heating module 8 corresponding to FIG. 2 without any covering by injection-molding. In this representation the distributor plate 18 made of aluminium as a stamped part onto which the heating unit 16 is clipped is clearly visible. For this purpose, on the outer periphery of a heating case 42 of the heating unit 16 ten snap-fits 44 are configured (only one thereof being provided with a reference numeral) which engage in corresponding locking recesses 46 of the distributor plate 18 so as to fix the heating case 42 of the heating unit 16 to the distributor plate 18.

On the heating case 42 the housing 30 of the connecting plug 10 is formed. The connecting pipe 32 is formed during injection-molding. As a basis, a flange ring 48 is integrally formed on the heating case 42. Said flange ring serves for sealing the ring-shaped heating transfer element 50 against the receiving chamber 68. The fluid-tight sealing may be realized by means of a sealing element (not shown) (e.g. O-ring) or an appropriate press fit. A ring-shaped heat transfer element 50 which is heated via the distributor plate 18 heating when current is supplied to the heating unit 16 immerses into said flange ring 48 of the fluid outlet 6. The heat transfer element 50 serves for heating the fluid outlet 6 so that the fluid exiting the tank is further heated and thus very quickly reaches its operating temperature.

The heating case 42 may be fabricated of plastic material resistant to temperature and urea, with the outer contour being configured with respect to optimum dimensional stability during injection molding and temperature resistance in operation.

The distributor plate 18 made of aluminium, for example, is a ground plate and—as will be explained in detail hereinafter—is in direct electric contact with the heating elements of the heating unit 16.

The relatively large opening 52 shown on the left in FIG. 4 after surrounding by injection-molding forms part of the return line for the urea solution. The other breakthroughs of the distributor plate 18 visible in FIG. 4 serve for receiving other functional elements or after injection-molding form the breakthroughs 24, 26 to enhance convection or to fix the injection-molding.

In FIG. 5 a bottom view of the heating module 8 corresponding to FIG. 3 is shown. This representation clearly shows the end portions of the snap-fits 44 immersing into the engaging recesses 46 so that the heating unit 16 is reliably connected to the distributor plate 18 already before it is covered by injection-molding.

In the shown example the heating transfer element 50 is bushing-shaped and is press-fitted into the distributor plate 18 and then projects upwards into the flange ring 48 of the heating unit 16.

In the representation according to FIG. 5 the reference numerals 54, 56 mark rivet-type fasteners being used to establish the ground contact. This is illustrated by way of FIG. 6 showing an example of the distributor plate 18. Accordingly, via the fasteners 54, 56 a ground contact 58 is fastened to the distributor plate 18 which in this case is an angular sheet and is connected to a corresponding ground contact of the connecting plug 12. Advantageously, the angular sheet already forms the contour of the contact 62 positioned in the connecting plug 12.

The end portion of the bushing-shaped heat transfer element 50 on the heating unit side protrudes from the large surface 20 of the distributor plate 18 towards the heating unit 16 (not shown in FIG. 6). In the pre-assembled state the end portion immerses into the flange ring 48. The other elements of the distributor plate 18 have been explained by way of the foregoing Figures so that any further remarks can be dispensed with.

FIG. 7 illustrates an example of the heating unit 16 including the heating case 42 made of injection molding onto which the ten snap-fits 44 are integrally formed. As explained before, also the housing 30 of the connecting plug 12 and the flange ring 48 are formed integrally onto the heating case 42. The casing 30 encompasses the contacts 62 of the connecting plug by which the ground contact 58 and the plus contact are made. The rectangular recesses or pouches 70 shown in FIG. 7 serve for minimizing the wall thickness of the heating case 16 and are optimized with respect to warp-free cooling and high dimensional stability. In addition, the strength is increased and the filling behavior is optimized during injection molding by means of the pouches 70.

FIG. 8 shows a view from the distributor plate 18 onto the heating unit 16. Accordingly, the heating case 42 is lid-shaped or hood-shaped and on the side of the distributor plate includes a circumferential edge 64 along which the heating case 42 rests on the large surface 20 of the distributor plate 18. In this supporting area a peripheral seal 66 is provided which may be in the form of a separately inserted sealing lip. However, it is also possible to form the seal 66 integrally with the heating case 42 by a multi-component injection molding process. This applies mutatis mutandis to the sealing of the ring-shaped heat transfer element 50.

The afore-mentioned ten snap-fits 44 are formed at the periphery of the hood-shaped or lid-shaped heating case 42. The heating case 42, jointly with the distributor plate 18 not visible in FIG. 8, delimits a receiving chamber 68 in which the actual heating elements are received. In the shown embodiment four PTC resistance elements 72a, 72b, 72c, 72d being connected to the positive contact of the connecting plug via a joint contact latch 74 are provided as heating elements. Instead of one single contact latch 74 also plural contact latches may be employed so that a multi-stage heating unit can be realized.

In the representation according to FIG. 8 also the opening area of the flange ring 48 on the receiving chamber side is visible into which the end portion of the heating transfer element 50 immerses in the mounted state. The PTC resistance elements 72 are also actuated in response to the signal of a NTC temperature sensor 76 used to sense the temperature of the heating unit. The temperature sensor 76 is inserted in an appropriate seat 78 of the heating case 42 and a contact is applied via the connecting plug 12.

In the representation according to FIG. 9 the four PTC resistance elements 72a to 72d are not shown. It is evident that the contact sheet 74 in the form of a stamped part is configured in the area of each PTC resistance element 72 having blanked out spring segments 80, 82 which protrude in the opposite direction of the PTC resistance elements 72a to 72d and are resilient adjacent to spring contact faces 88. The large surfaces of the PTC resistance elements 72a to 72d facing towards the viewer in FIG. 8 are fully biased to the distributor plate 18 by the spring bias so as to ensure establishing contacts. It is also advantageous that due to its elasticity this type of bias has a positive effect on the vibration behavior. As a matter of course, the biasing may also be brought about in a different way, for example by separately inserted spring elements.

The contact latch 74 used in the afore-described embodiment thus serves a double function: On the one hand, it represents the positive contact for the PTC resistance elements 72 to 72d, on the other hand it serves for spring-biasing said elements. Moreover, on the contact latch 74 a plug pin 83 is formed for connection to the positive contact of the connecting plug 12.

Advantageously, also the plug pin 83 made of the contact latch 74 already forms the contour of the contact 62 positioned in the connecting plug 12.

The lateral positioning of the contact latch 74 is carried out by a plurality of lateral stop blocks 84, 86.

FIG. 10 illustrates a representation corresponding to FIG. 9 with the contact latch 74 being removed. Then a support 90 for fixing the contact latch 74 in its position as well as the position of the temperature sensor 76 in the seat 78 is visible. The support 90 includes spring contact surfaces 88 for the spring segments 80, 82 with only one thereof being provided with a reference numeral in FIG. 10.

The actual sensor area of the thermal sensor 76 extends into the outside area of the heating case 42 (adjacent to the connecting plug 12) as represented in FIG. 7.

In unfavorable conditions fissuring may occur in the plastic material during covering by injection-molding/casting due to the different expansion coefficients of the plastic material and of the distributor plate resulting from thermal tensions so that the tightness of the system is impaired. In the afore-described embodiment thermal tensions of this type are avoided during cooling of the plastic material in that in the distributor plate breakthroughs 24, 26 or other recesses are formed by which those tensions are largely compensated. Unless the measures are sufficient to prevent fissuring, the heating module may be configured according to the designs as shown in FIGS. 11a to 11d, for example.

In FIG. 11 schematized cross-sectional profiles of the heating module 1 comprising the heating unit 16 and the distributor plate 18 electrically and thermally coupled to the heating unit 16 are shown. As illustrated in the foregoing, said subassembly is covered at least in portions by an injection-molding 28 in a fluid-tight manner. The term “covered by injection-molding” shall mean a sheathing which may preferably be carried out in an injection molding process, but also in any other way such as by immersing, sheathing by means of an enclosing body etc.

In the embodiment according to FIG. 11a the sheathing/covering injection-molding 28 is expanded in the peripheral area of the distributor plate 18 so that between the distributor plate 18 and the inner peripheral wall of the covering injection-molding 28 a compensating chamber 92 is retained which is filled with suitable compensation medium, for example compressible foam or suitable gas, preferably air. The compensating chamber 92 may be provided to be peripheral about the distributor plate 18 or else in the areas in which fissuring may occur. That is to say that such compensating chamber may as well be formed in the area of the large surfaces of the distributor plate or only in portions at the periphery.

FIG. 11b illustrates a variant in which the distributor plate 18 is configured to include beads 94 or any other relieving joints. The beads 94 are preferably formed in the areas susceptible to tensions, with the geometry of the beads/relieving joints 94 being appropriately chosen.

In the variant illustrated by way of FIG. 11a an advantage consists in the fact that the distributor plate 18 may further be designed as a comparatively simple plate-shaped component. In the example according to FIG. 11b the distributor plate has to be a stamped and bent part or the like so that greater manufacturing effort is required.

FIG. 11c illustrates a variant of the embodiment according to FIG. 11b. In this case the distributor plate 18 is configured to have wings 96 bent vis-à-vis the large plate surface in the marginal area, with the geometry of said wings being optimized with respect to compensation of tension. Such distributor plate 18, too, is a stamped and bent part.

The pairing of material (distributor plate 18, sheathing 28) is the same in the three afore-described variants, however; i.e. the distributor plate 18 may be manufactured of comparatively inexpensive basic material, for example aluminium. The covering injection-molding 28 may be completely fabricated by injection molding or the like, as described before.

It has to be observed in these examples that the spring contact faces 88 are configured so that contact of the spring segments 80, 82 is ensured.

FIG. 11d illustrates a variant in which merely the area of the heating unit 16 is covered by injection-molding 28′ by means of plastic material (injection molding, casting etc.). That is to say that the heating element 16 is provided with sort of a covering injection-molded hood. The latter may be appropriately connected to the distributor plate 18 in a fluid-tight manner. According to FIG. 11d, for this purpose anchoring breakthroughs 98 immersing into the marginal areas of the covering injection-molding 28′ may be formed in the distributor plate. In addition, also connecting elements 100 or sealing elements may be provided. The injection-molding 28′ and the elements for further sealing (98, 100) are designed so that the actual heating unit 16 is sheathed in a fluid-tight manner. The areas of the distributor plate 16 which are not covered by the covering injection-molding 28′ can be protected by painting or the like. In principle, it is also possible to configure the distributor plate of material resistant to the urea solution, for example VA. In FIG. 11 the painting is provided with the reference numeral 102. The advantage of this solution resides in the fact that the major part of the distributor plate 16 is not sheathed by injection-molding/casting etc. so that the tensions occurring and hence the formation of fissures can be reliably prevented.

A heating module and a tank system comprising the heating module are disclosed. The heating module has a heating unit which is equipped with at least one heating element, the heat thereof being transferred to an operating fluid via a plate-shaped distributor plate.

1. A heating module for melting or heating an operating fluid accommodated in a tank system, comprising:
a heating unit configured to transfer heat to the operating fluid via a heat distributing element, the heat distributing element including a substantially plate-shaped distributor plate supporting the heating unit on a first side, wherein at least the heating unit and at least part of the distributor plate are jointly sheathed.

2.-18. (canceled)

19. The heating module according to claim 1 wherein the heating unit and at least part of the distributor plate are jointly sheathed by surrounding the heating unit and the at least part of the distributor plate by injection molding in a fluid tight manner.

20. The heating module according to claim 1, wherein the distributor plate is made of a heat-conductive material such as aluminum.

21. The heating module according to claim 1, wherein the distributor plate is made by stamping.

22. The heating module according to claim 1, wherein a fluid outlet is formed on the heating unit and is in fluid communication with a suction connection on a second side of the distributor plate, the second side of the distributor plate being opposite the first side.

23. The heating module according to claim 1, wherein the distributor plate and the heating unit jointly form a receiving chamber for at least one heating element, with a ground connection being provided on a second side of the distributor plate and a positive connection being provided on the first side of the distributor plate, the second side of the distributor plate being opposite the first side.

24. The heating module according to claim 1, wherein a fluid outlet is heated in portions and passes through the heating unit as well as through the distributor plate and ends into a suction connection.

25. The heating module according to claim 24, further comprising a bushing-type heat transfer element arranged in the fluid outlet and being adapted to be heated via the heating unit.

26. The heating module according to claim 1, wherein a return passage is formed on a surface of a second side of the distributor plate, the return passage having a first end connecting into a suction connection and a second end connecting into a return inlet of the distributor plate, the second side of the distributor plate being opposite the first side.

27. The heating module according to claim 26, wherein the return passage is formed substantially by surrounding injection-molding.

28. The heating module according to claim 22, further comprising a mounting flange formed during surrounding injection-molding, the mounting flange encompassing an electric connection and the fluid outlet.

29. The heating module according to claim 28, wherein the mounting flange includes a welding flange.

30. The heating module according to claim 1, wherein a seat for a filter is formed on the distributor plate.

31. The heating module according to claim 1, wherein a seal is provided at a peripheral edge of the heating unit on a second side of the distributor plate, the second side of the distributor plate being opposite the first side.

32. The heating module according to claim 1, wherein a temperature sensor is incorporated in a receiving chamber of the heating unit.

33. The heating module according to claim 1, wherein the heating unit is pre-assembled with the distributor plate.

34. The heating module according to claim 1, wherein the at least one heating element of the heating unit is one of a PTC resistance element, a wire resistance element and a tubular heating element.

35. The heating module according to claim 1 further comprising springs received in a receiving chamber of the heating unit, the springs configured to bias the heating elements against the distributor plate.

36. The heating module according to claim 1, wherein at least the heating unit is sheathed and at least one of the distributor plate and the sheathing thereof is designed to compensate tensions occurring during surrounding the heating unit by injection molding.

37. A tank system comprising a tank including a heating module including:
a heating unit configured to transfer heat to the operating fluid via a heat distributing element, the heat distributing element including a substantially plate-shaped distributor plate supporting the heating unit of the heating module on a first side, wherein at least the heating unit and at least part of the distributor plate are jointly sheathed.
